(19) United States
(12) Patent Application Publication
(10) Pub. No.: US 2013/0112832 A1
(43) Pub. Date: May 9, 2013

(54) Systems and Methods for Supporting Mattresses

(71) Applicant: Randall D. Hilton, Castro Valley, CA (US)

(72) Inventor: Randall D. Hilton, Castro Valley, CA (US)

(21) Appl. No.: 13/292,019

(22) Filed: Nov. 8, 2011

(51) Int. Cl. F16M 13/00

(52) U.S. Cl. 248/354.1; 248/357

(57) ABSTRACT

The present invention relates to propping mattresses in a healthcare environment for easier access to bed tops. In one embodiment, a mattress support system supports a mattress edge. The support system includes a primary support member and a non-slip foot. The support system also includes a cross member rotatably coupled to the primary support member. The cross member includes left and right arms for supporting a corresponding pair of mattress straps. The primary support member may include a retainer for securing the cross member for ease of storage.

### BACKGROUND

The present invention relates to systems and methods for safely propping up one side of a mattress, enabling a user to, for example, clean the top of a bed, thereby enhancing worker safety.

In a healthcare environment such as in a hospital, nursing home or hospice care facility, beds need to be cleaned regularly to ensure hygienic conditions and satisfy internal processes and public health regulations. One particularly hard to reach and clean surface is the top of the bed frame, normally covered by the mattress.

When a person attempts to clean a bed frame top by himself or herself, he or she has to use one hand to prop up the mattress, leaving only one remaining hand free to clean this area under the mattress. Because some mattresses can be quite heavy, this process is both awkward and can potentially cause workplace injury.

It is therefore apparent that an urgent need exists for more efficient and safer methods and apparatus for propping mattresses during the cleaning process. Such an improved mattress support system should enable a user to efficiently and safely prop up the mattress, thereby freeing up both hands to clean the area of the bed otherwise covered by the mattress.

### SUMMARY

To achieve the foregoing and in accordance with the present invention, systems and methods for supporting mattresses in a healthcare environment are provided. In particular, systems and methods for propping up mattresses to free up both hands of a user so that the user has easy access to the top of bed which is normally covered by the mattress.

In one embodiment, a mattress support system is configured to support an edge of a mattress. The support system includes a primary support member and a foot coupled to an end of the primary support member to provide a non-slip contact surface between the primary support member and a ground surface. The support system also includes a cross member coupled to the primary support member, and wherein the cross member includes a left arm and a right arm configured to support a corresponding pair of straps of a mattress.

In some embodiments, the cross member is rotatably coupled to the upper portion of a primary support member, and the foot is a swivel foot configured to be rotatably coupled to the end of the primary support member.

The cross member can include an optional pair of hooks configured to support a corresponding pair of straps attached to the mattress. The primary support member can include an optional handle configured to provide a safe and convenient way to lift and move the support system from one location to another location. The primary support member can also include an optional retainer, such as a spring clip, configured to secure the cross member to the primary support member for storage.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1A is an exploded side view of an exemplary mattress support system, in accordance with one embodiment of the present invention;

FIG. 1B shows an assembled front view of the embodiment of FIG. 1A supporting a mattress;

FIG. 2 is a front view illustrating an enhanced embodiment of a mattress support system with “J” support hooks;

FIGS. 3A, 3B and 3C are isometric views showing the respective top portions of three more embodiments of mattress support systems incorporating quick-release cross members; and

FIGS. 4A and 4B illustrate yet another embodiment of a mattress support system incorporating a slide-through cross member.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

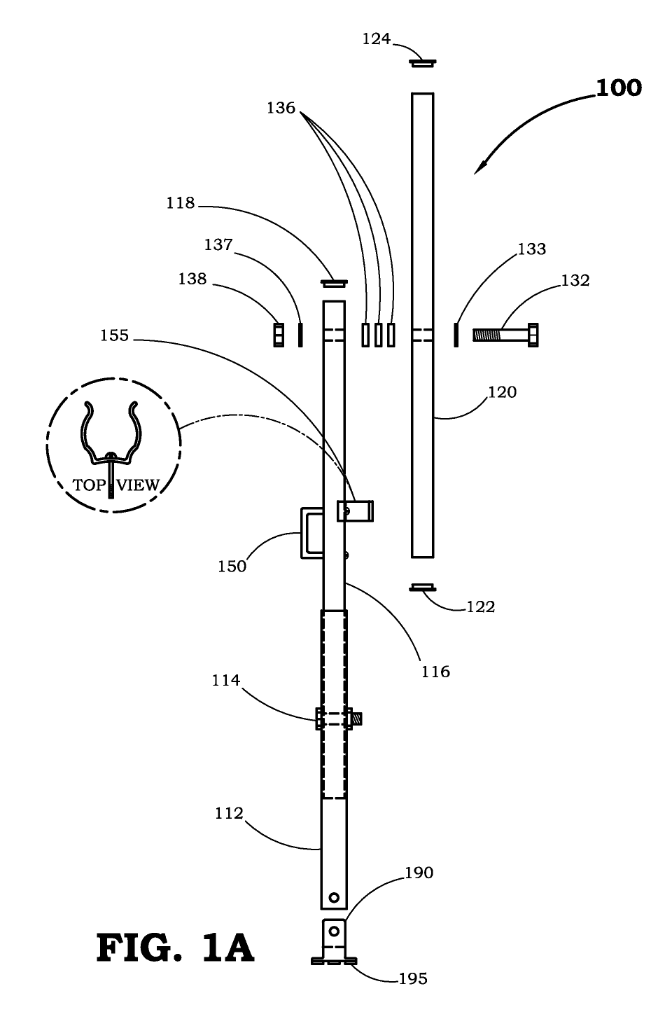

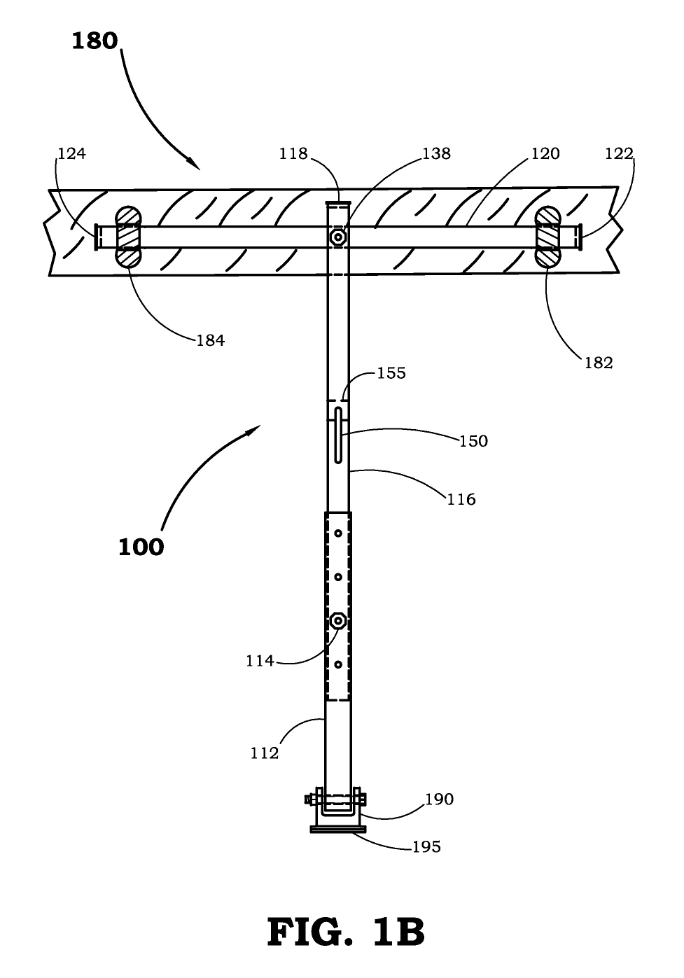

The present invention relates to systems and methods for supporting an edge of a mattress in a health care environment. To facilitate discussion, FIG. 1A shows an exploded side view of one embodiment of a mattress support system 100 which includes a primary support member having an upper section 116 and a lower section 112, a cross member 120, a handle 150, a retainer 155, and swivel foot 190 having a traction base 195. FIG. 1B is an assembled front view of support system 100 propping up one edge of a mattress 180.

In this embodiment, cross member 120 is rotatably coupled to upper section 116 via a threaded bolt 132, washer 133, spacers 136, washer 137 and a threaded nut 138. It will be appreciated that other rotatable coupling techniques are also possible, including rivets and split pins.

As shown in FIGS. 1A and 1B, the height of the cross member 120 relative to the ground can be adjusted by telescoping upper section 116 relative to lower section 112, and securing the two sections 112, 116 to each other with fastener 114 secured at the appropriate location. Other methods for adjusting the relative ground height of cross member 120 are also possible. For example, in another embodiment (not shown), the relative ground height of the cross member is adjusted by rotatably attaching the cross member to alternate locations along a primary support member having a single section.

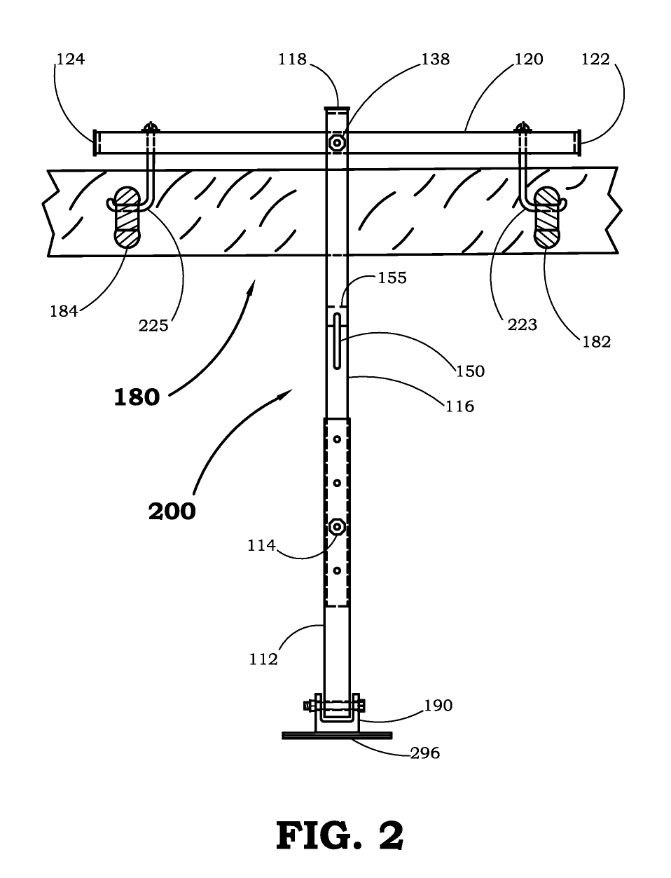

In this embodiment, a swivel foot 190 is rotatably coupled to a lower end of lower section 112. Foot 190 includes a fraction base, e.g., a rubber pad or non-slip tape, for minimizing slippage when support mattress 180. Depending on the specific application and cost requirement, a wide range of alternate foot choices for the mattress support system is also contemplated, and these choices include a simple rubber boot (not shown), or a wider swivel foot 296 with an extension wings as shown in FIG. 2. Other alternate foots include a foot with ball-and-socket joint (not shown).

For ease of storage, an optional retainer 155, e.g., a metal spring clip, can be used to secure cross member 120 to upper section 116. Other types of retainers are also contemplated, including Velcro™ straps, mechanical latches or magnetic latches.

In addition, an optional handle 150 provides a convenient means for carrying support system 100 from one location to another. Although a rigid handle 150 is illustrated in FIG. 1A, it is also possible to substitute handle 150 with a leather or synthetic strap.

Referring back to FIG. 1B, when a user needs to prop up one edge of mattress 180 to, for example, expose the upper surface of the bed (not shown) otherwise covered by the mattress 180, the respective ends of cross member 120 are inserted into mattress straps 182, 184. The user can now raise mattress 180 while sliding swivel foot 190 toward the bed, thereby elevating this edge of mattress 180. Having exposed the upper surface of the bed, user now has easy access and is able to clean this upper bed surface. Note that the opposite edge of mattress 180 remains in contact with the bed during this process, like a clamshell.

Alternatively, the mattress 180 can be raised by sliding swivel foot 190 from either the left side or the right side of the user, i.e., from an inclined orientation into a vertical orientation relative to the ground, while rotating cross member 120 relative to upper section 116, thereby elevating the edge of mattress 180.

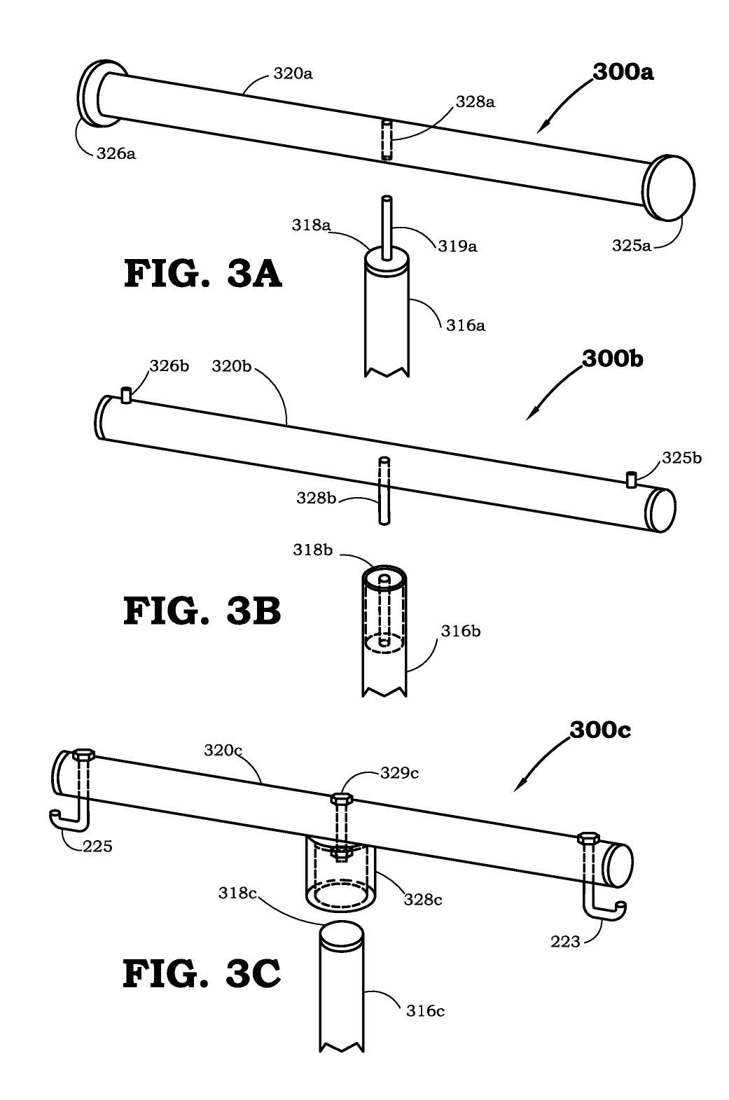

An optional pair of knobs or pegs 325b, 326b (see FIG. 3B) can also be attached near both ends of cross member 120 to minimize unintended movement of mattress straps 182, 184 along member 120, thereby preventing mattress straps 182, 184 from slipping off the ends of cross member 120.

In some embodiments, as shown in FIG. 2, a pair of optional “J” hooks 223, 225 are attached near the ends of cross member 120. As illustrated by FIGS. 1B and 2, it is substantially easier to insert hooks 223, 225 into mattress straps 182, 184 than trying to inserting the ends of cross member 120 into straps 182, 184. Hooks 223, 225 also support the edge of mattress 180 in a more secure manner, since straps 182, 184 are less likely to slide off hooks 223, 225.

It can be appreciated that other methods for securing the edge of mattress 180 to cross member 120 are also possible. For example, corresponding Velcro™ strips can be affixed to both cross member 120 and the edge of mattress 180 (not shown). Mechanical fasteners such as snap buttons can also be used.

Support system 100 or 200 can be made from a variety of suitable materials. For example, as a low-cost and lightweight embodiment, sections 112, 116 and/or member 120 can be manufactured by using PVC Schedule 80 round pipes. Since PVC pipes are slightly flexible, optional retainer 155 can be oriented in the direction shown in FIG. 1A, since the end of cross-member 120 can be bent slightly as it is being secured to upper section 116.

Alternatively, support system 100 or 200 can also be a higher-cost, heavy-duty embodiment manufactured using stronger and/or stiffer materials such as steel, aluminum, fiberglass or carbon fiber tubing. With such stiffer materials, the optional retainer 155 should preferably be oriented sideway (not shown) so that the cross member 120 does not have to be bent, in a direction away from upper section 116, in order to be engaged by retainer 155.

It is also contemplated that sections 112, 116 and/or member 120 can also have other cross-sectional profiles, for example, using square tubing instead of round tubing. Other materials for fabricating sections 112, 116 and/or member 120 are also possible, including solid materials such as wooden or plastic rods.

It is also possible to attach the bottom of a primary support member of a mattress support system directly to a suitable part of a bed, e.g., a socket or bracket of the bed frame (not shown). Alternatively, it may also possible to adapt the bottom of primary support member to secure to the edge of an unmodified bed frame, e.g., by attaching a magnetic foot to the primary support member to be secured to a steel bed frame.

In another embodiment (not shown), the primary support member can be constructed using a single fixed length member in place of the telescoping two-piece design with upper portion 116 and lower portion 112 as shown in FIGS. 1A, 1B and 2.

In yet another embodiment (not shown), a spring-loaded roller foot is rotatably attached to the bottom of primary support member. The concept used is similar to that implemented in a ladder that can be rolled around and as soon as a person steps on to such ladder, the rollers springs are depressed sufficiently to allow the ladder legs sink downwards and come into firm contact with the ground.

Referring now to FIG. 3A illustrating another embodiment 300a incorporating a quick-release cross member 320a, the upper portion of the primary support member 316a includes an end cap 318a with a pin 319a configured to engage a corresponding hole 328a of cross member 320a. It is contemplated that the pin 319a and hole 328a can have a variety of matching round, square or polygonal cross-sections. Pin 319a can also be tapered slightly towards a rounded tip for ease of engagement with and release from the hole 328a.

In embodiment 300a, cross member 320a includes end caps 325a, 326a with oversized rims for minimizing slippage when cross member 320a is inserted through the mattress straps (not shown). The rims of end caps 325a, 326a can have a convex radius to ease insertion and removal from the mattress straps.

Conversely as shown in the embodiment 300b of FIG. 3B, cross member 320b include a pin 328b for engaging with a corresponding hole of end plug 318b located in the upper portion of primary support member 316b. Pin 328b can also be tapered slightly towards a rounded tip for ease of engagement with and release from end plug 318b. To minimize slippage from mattress straps, a pair of pegs 325b, 326b is mounted near the respective ends of cross member 320b. These pegs 325b, 326b can be mounted to cross member 320b using many known techniques including mechanical means, adhesives or ultrasonic bonding.

FIG. 3C shows yet another quick-release embodiment 300c with cross-member 320c configured for mounting over the top portion of primary support member 316c. This is accomplished by attaching a socket 328c to the middle of cross member 320c, with, for example, screw and nut 329c. The end cap 318c of primary support member 316c may be rounded for ease of insertion into and removal from socket 328c.

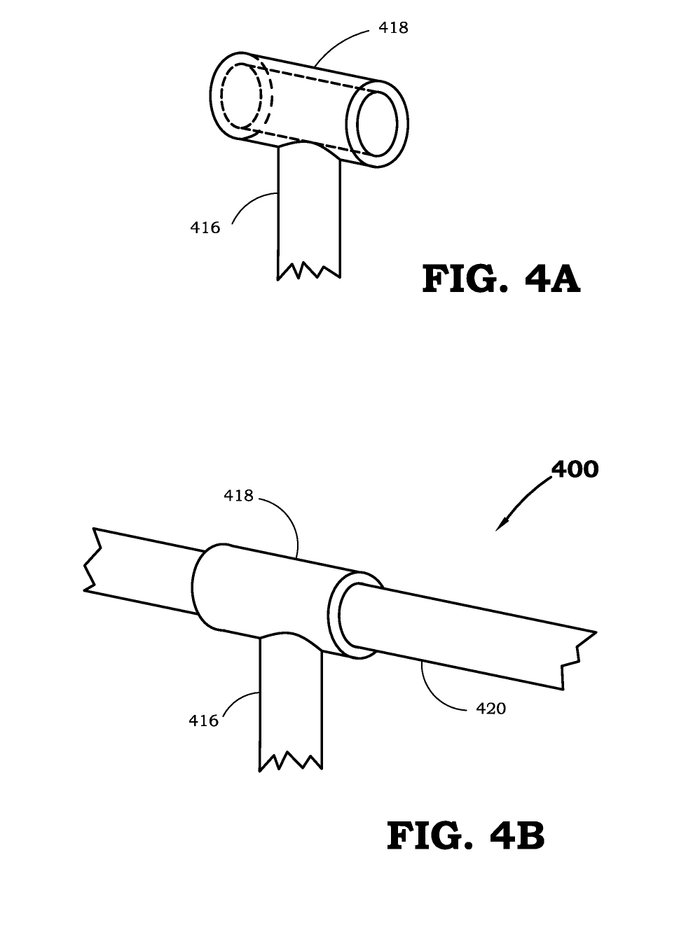

FIGS. 4A and 4B illustrate another embodiment 400 with a slide-through cross member 420. Accordingly, a corresponding short tube 418 is mounted onto the top portion of primary support member 416 for receiving and supporting the cross member 420. The tube 418 can be mounted to primary support member 416 using many known techniques such as mechanical means, adhesives or ultrasonic bonding.

Other modifications are also possible. For example, the primary support member may be pre-spring-loaded to about half of the expected weight needed to raise one edge of the mattress, thereby reducing the effort required to raise the mattress.

While this invention has been described in terms of several embodiments, there are alterations, modifications, permutations, and substitute equivalents, which fall within the scope of this invention. Hence, it should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A mattress support system configured to support an edge of a mattress, the support system comprising:
a primary support member;
a foot coupled to an end of the primary support member, wherein the foot is configured to provide a non-slip contact surface between the primary support member and a ground surface; and
a cross member coupled to the primary support member, and wherein the cross member includes a left arm and a right arm configured to support a corresponding pair of straps of a mattress.

2. The mattress support system of claim 1 wherein the cross member is rotatably coupled to the primary support member.

3. The mattress support system of claim 1 further comprising a handle configured to provide a safe and convenient way to lift and move the support system from one location to another location.

4. The mattress support system of claim 1 wherein the foot is a rubber boot configured to slip over the end of the primary support member.

5. The mattress support system of claim 1 wherein the foot is a swivel foot configured to be rotatably coupled to the end of the primary support member.

6. The mattress support system of claim 1 wherein the foot is a non-slip boot configured to be rotatably coupled to the end of the primary support member.

7. The mattress support system of claim 1 wherein the foot is a ball-and-socket foot configured to be rotatably coupled to the end of the primary support member.

8. The mattress support system of claim 2 wherein the primary support member includes a retainer configured to secure the cross member to the primary support member for storage.

9. The mattress support system of claim 8 wherein the retainer is a spring clip or a Velcro strap.

10. The mattress support system of claim 1 wherein the height of the support system is adjustable and wherein the primary support member includes an upper section and a lower section, and wherein the upper section is configured to telescope from the lower section.

11. The mattress support system of claim 1 wherein the cross member includes a pair of hooks configured to support a corresponding pair of straps attached to the mattress.

12. The mattress support system of claim 1 wherein the cross member includes a pair of pegs configured to minimize slippage of a corresponding pair of straps attached to the mattress.

13. The mattress support system of claim 1 wherein the cross member includes a pair of end caps with oversized rims configured to minimize slippage of a corresponding pair of straps attached to the mattress.

14. The mattress support system of claim 1 wherein the cross member is configured to slide through a tube coupled to the primary support member.

15. A method for supporting an edge of a mattress in a health care environment, the method comprising:
sliding a cross member of a support system through a pair of straps located on an edge of a mattress, wherein the mattress is located on a surface of a bed, and wherein the cross member is coupled to a primary support member; and
sliding a foot of the primary support member towards the bed, thereby causing the cross member to rise which in turn causes the edge of mattress to rise relative to the surface of the bed.

16. The method of claim 15 wherein the cross member is rotatably coupled to the primary support member.

17. The method of claim 15 wherein the support system includes a handle configured to provide a safe and convenient way to lift and move the support system from one location to another location.

18. The method of claim 15 wherein the foot is a swivel foot configured to be rotatably coupled to the end of the primary support member.
